(19) United States
(12) Patent Application Publication
(10) Pub. No.: US 2025/0039672 A1
(43) Pub. Date: Jan. 30, 2025

(54) PERSONAL INFORMATION PROTECTION APPARATUS AGAINST DIGITAL HACKING AND ITS METHOD

(71) Applicant: Jin Sung Lee, Seoul (KR)

(72) Inventor: Jin Sung Lee, Seoul (KR)

(21) Appl. No.: 18/820,181

(22) Filed: Aug. 29, 2024

(30) Foreign Application Priority Data
Jul. 27, 2023 (KR) 10-2023-0098413

(51) Int. Cl. H04W 12/122; H04W 8/18; H04W 12/128

(52) U.S. Cl. CPC H04W 12/122; H04W 8/183; H04W 12/128

(57) ABSTRACT

A personal information protection method includes a first step comprising rooting a victim's device where digital hacking has occurred to obtain administrator privileges, and installing a dedicated application software on the victim's device; a second step comprising analyzing the packet information of the malware installed on the victim's device to extract information about the attacking server; a third step comprising analyzing the actual data stored on the victim's device to continuously generate fake data (such as contacts, names, email addresses, and various images) in the same or similar format as the actual data and storing the fake data on the victim's device; a fourth step comprising ensuring that the fake data is continuously transmitted from the victim's device to the attacking server, thereby preventing the attacking server from identifying the victim's personal information.

### BACKGROUND OF THE INVENTION

The present invention relates to a personal information protection apparatus and the method thereof. More specifically, the present invention involves using generative AI to create fake data, which is continuously sent to an attacking server to disrupt data collection and prevent an attacker from identifying actual victim's data, thereby protecting personal information against digital hacking.

Recently, communication terminal device, such as smartphones with mobile operating systems like Windows Mobile, iOS (Operating System), and Android, has been widely used.

The device run various application software based on the respective mobile operating systems to provide users with diverse information processing services.

Additionally, communication terminal device with mobile operating systems is equipped with browsers as application software, enabling users to access various websites by connecting to the internet.

The communication terminal device, such as smartphones with mobile operating systems, are vulnerable to digital hacking through a malware.

A malware, or malicious software, encompasses all software that infringes on users' interests, ranging from simple computer worms and Trojan horses to the most complex forms of computer viruses. Malware can affect not only the infected device but also other devices that communicate with the infected device.

Personal information leaks due to such malware are commonplace, and the resulting damage is expanding.

Although various security technologies have been proposed to address the issue, there is an increasing need for technologies that can neutralize personal information leaks if digital hacking by malware leads to data breaches.

PRIOR ARTS: Korea Patent Registration No. 10-2197005 (Dec. 23, 2020)

### SUMMARY OF THE INVENTION

Therefore, the purpose of the present invention is to provide a personal information protection apparatus and the method thereof against digital hacking that can overcome the aforementioned conventional problems.

Another purpose of the present invention is to create fake data to protect personal information compromised by digital hacking. The fake data is continuously transmitted to an attacking server, disrupting the server's data collection and preventing an attacker from identifying the actual victim's data, thereby safeguarding personal information.

According to the embodiment of the present invention for achieving the aforementioned technical problems, a method for protecting personal information comprising: a first step of rooting a victim's device on which digital hacking has been conducted to obtain administrator privileges and installing a dedicated application software on the victim's device; a second step of analyzing packet information of a malware installed on the victim's device to extract information about an attacking server; a third step of continuously generating fake data, including contacts, names, email addresses and images, in the same or similar form to actual data by analyzing the actual data stored on the victim's device, and storing the fake data on the victim's device; and a fourth step of ensuring that the fake data is continuously transmitted to the attacking server through the victim's device so that the attacking server cannot identify the victim's personal information.

The first step or the second step further comprises a step of deactivating the malware, and the transmission of the fake data at the fourth step is performed by activating the malware.

the first step or the second step further comprises a step of deactivating the malware, and the transmission of the fake data at the fourth step is executed a separate mimic application embedded within the dedicated application software to directly transmit the fake data to the attacking server.

The fake data at the third step is generated using a generative AI to ensure that the fake data does not follow a specific pattern and does not have content similarity.

According to another embodiment of the present invention for achieving the aforementioned technical problems, a method for protecting personal information comprising: a first step of rooting an unregistered device to obtain administrator privileges, changing International Mobile Equipment Identity (IMEI) of the unregistered device to International Mobile Equipment Identity (IMEI) of the victim's device which has been digitally hacked, and synchronizing the unregistered device with the victim's device; a second step of analyzing packet information of a malware installed on the victim's device to extract information about an attacking server; a third step of continuously generating fake data, including contacts, names, email addresses and images, in the same or similar form to actual data by analyzing the actual data stored on the victim's device and storing the fake data on the unregistered device; and a fourth step of ensuring that the fake data is continuously transmitted to the attacking server through the unregistered device, so that the attacking server cannot identify the victim's personal information.

The first or the second step further comprises a step of deactivating the malware, and the transmission of the fake data at the fourth step is performed by running a separate mimic application on the unregistered device to directly transmit the fake data to the attacking server based on the information about the attacking server.

The fake data at the third step is generated using a generative AI to ensure that the fake data does not follow a specific pattern and does not have content similarity.

According to another embodiment of the present invention for achieving the aforementioned technical problems, an apparatus for protecting personal information comprising: an information collection unit rooting a victim's device, which has been digitally hacked, or an unregistered device to obtain administrator privileges and analyzing packet information of a malware installed on the victim's device to extract information about an attacking server; a fake data generation unit continuously generating fake data, including contacts, names, email addresses and images, in the same or similar form to actual data by analyzing the actual data stored on the victim's device and storing the fake data on the victim's device or the unregistered device; and an information protection unit ensuring the fake data is continuously transmitted to the attacking server through the victim's device or the unregistered device, so that the attacking server cannot identify the victim's personal information.

The information collection unit, in the case of rooting the unregistered device to obtain administrator privileges, changes International Mobile Equipment Identity (IMEI) of the unregistered device to International Mobile Equipment Identity (IMEI) of the victim's device, which has been digitally hacked, and synchronizes the unregistered device with the victim's device.

The information about the attacking server includes server address, port, and protocol.

According to the present invention, there is an advantage in protecting personal information compromised by digital hacking by continuously sending fake data generated using generative AI to the attacking server, and disrupting the server's data collection and preventing an attacker from identifying the actual victim's data, and thereby safeguarding personal information. Additionally, there is an advantage in protecting personal information by using unregistered devices to impersonate the victim's device and transmit fake data, further disrupting the attacking server's data collection and preventing the attacker from identifying the actual victim's data.

### BRIEF DESCRIPTION OF THE DRAWINGS

FIG. 1 is a schematic block diagram of a personal information protection apparatus according to the first embodiment of the present invention.

FIG. 2 is a flowchart of the operation of the personal information protection apparatus in FIG. 1.

FIG. 3 is a schematic block diagram of a personal information protection apparatus according to the second embodiment of the present invention.

FIG. 4 is a flowchart of the operation of the personal information protection apparatus in FIG. 3.

### DETAILED DESCRIPTION OF THE INVENTION

Hereinafter, the preferred embodiments of the present invention will be described in detail with reference to the accompanying drawings. The descriptions are provided solely to offer a thorough understanding of the present invention to those skilled in the art, without any other intended purpose.

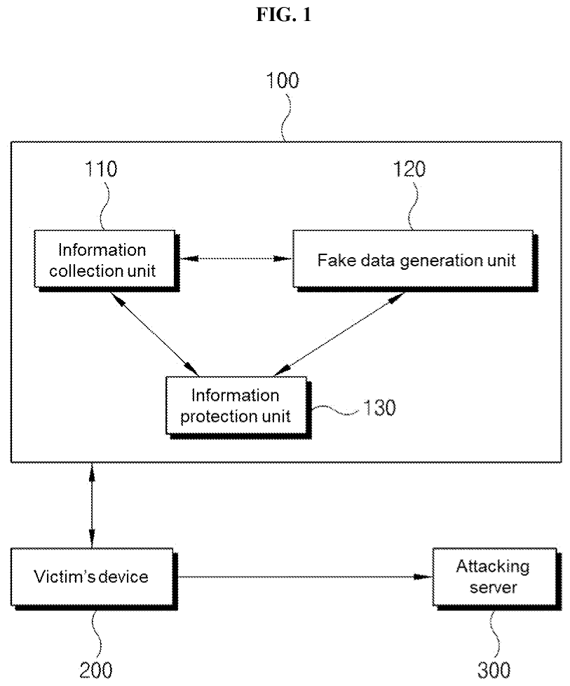

FIG. 1 is a schematic block diagram of a personal information protection apparatus according to the first embodiment of the present invention.

As shown in FIG. 1, the personal information protection apparatus (100) according to the first embodiment of the present invention is designed to disrupt data collection of an attacking server (300) and make it difficult for an attacker to identify actual personal information of a victim, thereby protecting the personal information that has been or is being leaked from the victim's device (200). The victim's device (200) can be a desktop, laptop, tablet PC, or smartphone. In the present invention, a smartphone is used as an example for explanation.

The personal information protection apparatus (100) includes an information collection unit (110), a fake data generation unit (120), and an information protection unit (130).

The information collection unit (110) gains administrator privileges by rooting the victim's device (200), which is undergoing or has already undergone digital hacking and personal information leakage. The information collection unit (110) installs a dedicated application software (hereinafter referred to as the “dedicated app”) on the victim's device and analyzes packet information of a malware installed on the victim's device to extract information about the attacking server (300).

Rooting the victim's device (200) grants direct administrator privileges, allowing for various system modifications such as overclocking and global ROM customization. By installing a custom ROM, it is possible to replace the existing operating system. Additionally, external memory can be utilized to significantly increase storage capacity for handling large amounts of data. Rooting also allows access to system files, enabling their modification. After rooting, the dedicated app can be easily installed on the victim's device (200), facilitating the exploration of various countermeasures.

The information collection unit (110) uses packet capture utilities (e.g., capture software such as Wireshark) to capture and analyze packets from the malware. The process enables the tracking of the malware server, or the attacking server (300), by obtaining its address and protocol. In other words, through packet analysis of phishing files, it is possible to identify the attacking server (300) or its socket server. The information about the attacking server may include server address, port, protocol, and other related details.

The fake data generation unit (120) analyzes the actual data stored on the victim's device (200) and continuously generates fake data in the same or similar format as the actual data, such as contacts, names, email addresses, and various images. The fake data is then stored on the victim's device (200).

The fake data can be generated using generative AI in a manner that avoids specific patterns and does not maintain content similarity. For example, it may involve using an AI-based software, such as an AI generator based on an Express framework and powered by ChatGPT.

The fake data generation unit (120) may create fake data. In case of names, the fake data generation unit (120) may generate a number of names similar to those stored on the victim's device (200), such as Korean-style names with 2-3 characters. In case of emails, the fake data generation unit (120) may create fake data by defining domain risks, selects random domains, and creating email IDs with random character combinations. Alternatively, emails can be generated using AI or separate algorithms. In case of phone numbers, the fake data generation unit (120) may generate phone numbers randomly using the same method, combining random digits to match the required number of digits. In case of images, the fake data generation unit (120) may create a specified number of meaningless images using generative AI. Additionally, the fake data generation unit (120) can generate various types of fake data based on personal information stored on the victim's device (e.g., social security numbers, account numbers, various passwords).

Unlike traditional methods, the present invention uses generative AI to create fake data. When fake data is created manually, such as by making dummy data, it tends to follow specific patterns because it is artificially generated by humans. As the volume of data increases, there is a possibility that the attacking server (300) may block and delete similar data over time. In contrast, when using generative AI, new data is continuously created in forms similar to the actual data, making it impossible for the attacker to discern specific patterns or similarities in the content.

The information protection unit (130) ensures that fake data is continuously or repeatedly transmitted from the victim's device (200) to the attacking server (300), preventing the server from identifying the victim's personal information. For example, by reactivating an APK (Android Application Package) file received from the attacker, the fake data is automatically sent to the attacking server (300). This makes it difficult to identify specific data and effectively obscures the victim's personal information. From the perspective of the attacking server (300), the victim is identified by International Mobile Equipment Identity (IMEI). Since new data is transmitted from a device with the same IMEI, the server cannot identify the actual victim's information.

Here, the APK file, which is malware received from the attacker, can be deactivated before the generation of fake data and reactivated during the transmission of the fake data to ensure that the data is sent. Alternatively, the malware APK can be deactivated before generating the fake data and, after the fake data is generated, a separate mimic application embedded in the dedicated app can be executed to directly send the fake data to the attacking server (300).

By sending the fake data to the address of the attacking server (300) based on the server information obtained through the information collection unit (110), it becomes difficult for the attacking server (300) to identify the victim's actual data. Consequently, the protection of the victim's personal information is ensured.

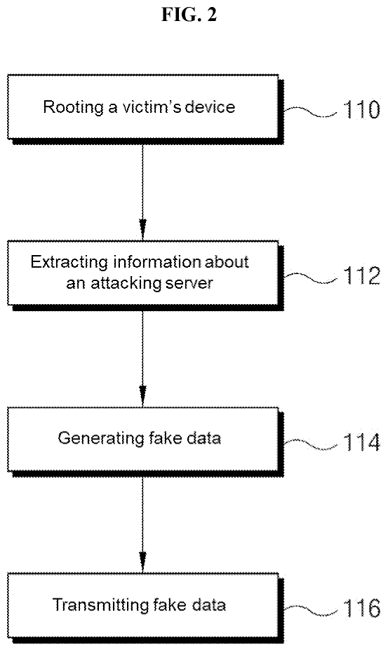

FIG. 2 is a flowchart of the operation of the personal information protection apparatus in FIG. 1.

As shown in FIG. 2, the method for protecting personal information using the personal information protection apparatus (100) according to the first embodiment of the present invention includes the following steps. The first step is to identify the victim's device (200) where digital hacking is in progress or has occurred and root the victim's device (200) to gain administrator privileges and install and activate the dedicated app on the victim's device (200) (S110).

Next step is to use a packet analysis software, such as a packet capture utility, to analyze the packet information of the malware installed on the victim's device (200) and extract information about the attacking server (S112). The attacking server's address, port, protocol, etc. are extracted and databased. At this stage, the malware installed on the victim's device (200) may be deactivated. Then, the step further includes analyzing the actual data stored on the victim's device (200) to continuously generate fake data in the same or similar format as the actual data, such as contacts, names, email addresses, and various images, and storing the fake data on the victim's device (200) (S114). The actual data on the victim's device (200) can be either deleted or stored in a separate cloud or other storage.

Additionally, the step further includes ensuring that the fake data is continuously or repeatedly transmitted from the victim's device (200) to the attacking server (300) to prevent the server from identifying the victim's personal information, thereby protecting the personal information (S116).

The transmission of fake data can be accomplished either by activating the malware to perform the task or by running a separate mimic application embedded in the dedicated app to directly send the fake data to the attacking server (300).

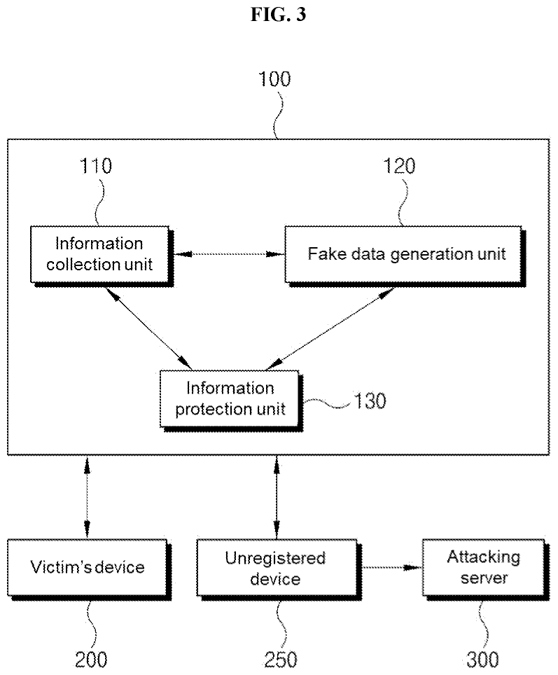

FIG. 3 is a schematic block diagram of a personal information protection apparatus according to the second embodiment of the present invention.

As shown in FIG. 3, the personal information protection apparatus (100) according to the second embodiment of the present invention uses an unregistered device (250) to protect personal information that has been or is being leaked from the victim's device (200). It aims to disrupt the data collection of the attacking server (300) and make it difficult for the attacker to identify the victim's actual personal information.

The victim's device (200) and the unregistered device (250) can be any of a desktop, laptop, tablet PC, or smartphone. In the present invention, a smartphone is used as an example for explanation.

The unregistered device (250), also known as a “spare device,” refers to a device that is not registered with a carrier.

In the second embodiment of the personal information protection apparatus (100), the apparatus is equipped with an information collection unit (110), a fake data generation unit (120), and an information protection unit (130). The method thereof involves rooting the unregistered device (250) to gain administrator privileges and disguising it as the victim's device (200).

The information collection unit (110) may root the unregistered device (250) to gain administrator rights, installs the dedicated app on it, and change the International Mobile Equipment Identity (IMEI) of the unregistered device (250) to match that of the victim's device (200), thereby synchronize the unregistered device (250) to appear as the victim's device (200).

The information collection unit (110) also may analyze the packet information of the malware installed on the victim's device (200) to extract information about the attacking server (300).

Using packet capture utilities (e.g., capture programs such as Wireshark), The information collection unit (110) may capture and analyze malware packets to trace the address and protocol of the attacking server (300). This allows for the identification of the attacking server (300) or its socket server through packet analysis of phishing files. The attacking server information may include the server address, port, protocol, etc.

The fake data generation unit (120) may analyze the actual data stored on the victim's device (200) and continuously generate fake data in forms identical to or similar to the actual data, such as contacts, names, email addresses, and various images, which is then stored on the unregistered device (250).

The fake data is created using generative AI in a way that avoids specific patterns and content similarity. For example, an AI generator program based on ChatGPT and Express may be included.

The fake data generation unit (120) may create fake data. In case of names, the fake data generation unit (120) may generate a number of names similar to those stored on the victim's device (200), such as Korean-style names with 2-3 characters. In case of emails, the fake data generation unit (120) may create fake data by defining domain risks, selects random domains, and creating email IDs with random character combinations. Alternatively, emails can be generated using AI or separate algorithms. In case of phone numbers, the fake data generation unit (120) may generate phone numbers randomly using the same method, combining random digits to match the required number of digits. In case of images, the fake data generation unit (120) may create a specified number of meaningless images using generative AI. Additionally, the fake data generation unit (120) can generate various types of fake data based on personal information stored on the victim's device (e.g., social security numbers, account numbers, various passwords).

Unlike traditional methods, the present invention uses generative AI to create fake data. When fake data is created manually, such as by making dummy data, it tends to follow specific patterns because it is artificially generated by humans. As the volume of data increases, there is a possibility that the attacking server (300) may block and delete similar data over time. In contrast, when using generative AI, new data is continuously created in forms similar to the actual data, making it impossible for the attacker to discern specific patterns or similarities in the content.

The information protection unit (130) may ensure that fake data is continuously or repeatedly transmitted to the attacking server (300) through the unregistered device (250), making it difficult for the attacking server (300) to identify the victim's personal information.

For example, by reactivating the APK (Android Application Package) file received from the attacker, the fake data can be automatically sent to the attacking server (300), complicating data identification and effectively altering the victim's personal information. From the perspective of the attacking server (300), it identifies the victim using the International Mobile Equipment Identity (IMEI). However, since the IMEI of the unregistered device (250) is the same, even if new data is transmitted from the unregistered device (250), the server will still recognize it as the victim's data, making it impossible to identify the actual victim's information.

Here, the transmission of the fake data can be accomplished by running a separate mimic application embedded in the dedicated app on the unregistered device (250) to directly send the fake data to the attacking server (300). By sending the fake data to the address of the attacking server (300) based on the server information obtained through the information collection unit (110), it becomes difficult for the attacking server (300) to identify the victim's actual data. Consequently, the method ensures the protection of the victim's personal information.

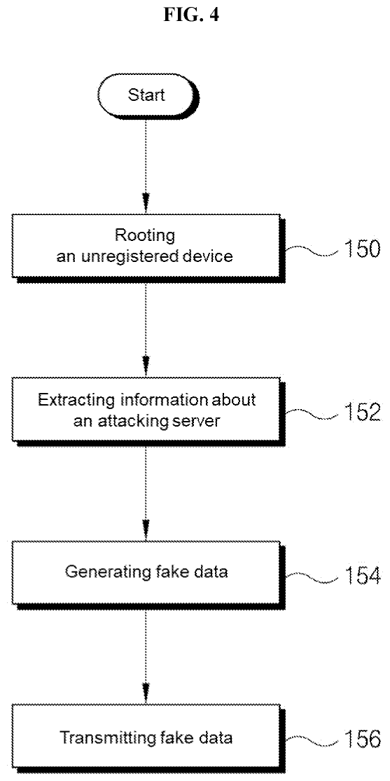

FIG. 4 is a flowchart of the operation of the personal information protection apparatus in FIG. 3.

As shown in FIG. 4, the method for protecting personal information using the personal information protection device (100) according to the first embodiment of the present invention includes the following steps. The first step is to identify the victim's device (200) where digital hacking is occurring or has occurred, root a separate unregistered device (250) to gain administrator privileges, and install and activate the dedicated app on the unregistered device (250) (S150).

The next step is to use packet analysis software, such as packet capture utilities, to analyze the packet information of the malware installed on the victim's device (200) and extract information about the attacking server (300) (S152). Extract and database the address, port, and protocol of the attacking server.

Then, the step further includes analyzing the actual data stored on the victim's device (200) and continuously generate fake data in forms identical to or similar to the actual data, such as contacts, names, email addresses, and various images, which is then stored on the unregistered device (250) (S154).

Then, the step further includes ensuring that the fake data is continuously or repeatedly transmitted to the attacking server (300) via the unregistered device (250), so that the attacking server (300) is unable to identify the victim's personal information, thereby protecting the victim's privacy (S156).

The transmission of the fake data can also be accomplished by running a separate mimic application embedded in the dedicated app to directly send the fake data to the attacking server (300).

As described above, the present invention has the advantage of protecting personal information stolen through digital hacking by continuously sending fake data generated using generative AI to the attacking server, thereby interfering with the server's data collection and preventing the attacker from identifying the actual victim's data. Additionally, by using an unregistered device to impersonate the victim's device and sending fake data, it further disrupts the server's data collection and prevents the attacker from identifying the real victim's information.

The above description of the embodiments is merely provided for a more thorough understanding of the present invention with reference to the drawings and should not be interpreted as limiting the scope of the invention. Additionally, it is evident that various modifications and changes can be made within the scope of the basic principles of the present invention, as understood by those skilled in the relevant technical field.

### DESCRIPTION OF REFERENCE NUMERALS

110: Information Collection Unit
120: Fake Data Generation Unit
130: Information Protection Unit
200: Victim's Device
250: Unregistered Device
300: Attacking Server

1. A method for protecting personal information comprising:
a first step of rooting a victim's device on which digital hacking has been conducted to obtain administrator privileges and installing a dedicated application software on the victim's device;
a second step of analyzing packet information of a malware installed on the victim's device to extract information about an attacking server;
a third step of continuously generating fake data, including contacts, names, email addresses and images, in the same or similar form to actual data by analyzing the actual data stored on the victim's device, and storing the fake data on the victim's device; and
a fourth step of ensuring that the fake data is continuously transmitted to the attacking server through the victim's device so that the attacking server cannot identify the victim's personal information.

2. The method of claim 1, wherein the first step or the second step further comprises a step of deactivating the malware, and the transmission of the fake data at the fourth step is performed by activating the malware.

3. The method of claim 1, wherein the first step or the second step further comprises a step of deactivating the malware, and the transmission of the fake data at the fourth step is executed a separate mimic application embedded within the dedicated application software to directly transmit the fake data to the attacking server.

4. The method of claim 1, wherein the fake data at the third step is generated using a generative AI to ensure that the fake data does not follow a specific pattern and does not have content similarity.

5. A method for protecting personal information comprising:
a first step of rooting an unregistered device to obtain administrator privileges, changing International Mobile Equipment Identity (IMEI) of the unregistered device to International Mobile Equipment Identity (IMEI) of the victim's device which has been digitally hacked, and synchronizing the unregistered device with the victim's device;
a second step of analyzing packet information of a malware installed on the victim's device to extract information about an attacking server;
a third step of continuously generating fake data, including contacts, names, email addresses and images, in the same or similar form to actual data by analyzing the actual data stored on the victim's device and storing the fake data on the unregistered device; and
a fourth step of ensuring that the fake data is continuously transmitted to the attacking server through the unregistered device, so that the attacking server cannot identify the victim's personal information.

6. The method of claim 5, wherein the first or the second step further comprises a step of deactivating the malware, and the transmission of the fake data at the fourth step is performed by running a separate mimic application on the unregistered device to directly transmit the fake data to the attacking server based on the information about the attacking server.

7. The method of claim 5, wherein the fake data at the third step is generated using a generative AI to ensure that the fake data does not follow a specific pattern and does not have content similarity.

8. An apparatus for protecting personal information comprising:
an information collection unit rooting a victim's device, which has been digitally hacked, or an unregistered device to obtain administrator privileges and analyzing packet information of a malware installed on the victim's device to extract information about an attacking server;
a fake data generation unit continuously generating fake data, including contacts, names, email addresses and images, in the same or similar form to actual data by analyzing the actual data stored on the victim's device and storing the fake data on the victim's device or the unregistered device; and
an information protection unit ensuring the fake data is continuously transmitted to the attacking server through the victim's device or the unregistered device, so that the attacking server cannot identify the victim's personal information.

9. The apparatus of claim 8, wherein the information collection unit, in the case of rooting the unregistered device to obtain administrator privileges, changes International Mobile Equipment Identity (IMEI) of the unregistered device to International Mobile Equipment Identity (IMEI) of the victim's device, which has been digitally hacked, and synchronizes the unregistered device with the victim's device.

10. The apparatus of claim 8, wherein the information about the attacking server includes server address, port, and protocol.
